(19) United States
(12) Patent Application Publication
(10) Pub. No.: US 2016/0105539 A1
(43) Pub. Date: Apr. 14, 2016

(54) VEHICLE INTERFACE DOCKING SYSTEM FOR DSRC-EQUIPPED USER DEVICES IN A VEHICLE

(71) Applicant: THE REGENTS OF THE UNIVERSITY OF MICHIGAN, Ann Arbor, MI (US)

(72) Inventors: John M. MADDOX, Ann Arbor, MI (US); James Richard SAYER, Ann Arbor, MI (US); Andre WEIMERSKIRCH, Ann Arbor, MI (US)

(21) Appl. No.: 14/882,906

(22) Filed: Oct. 14, 2015

Related U.S. Application Data
(60) Provisional application No. 62/063,443, filed on Oct. 14, 2014.

(51) Int. Cl. H04M 1/725; H04W 4/00; H04W 12/06; H04B 1/3877; H04B 1/3822

(52) U.S. Cl. CPC H04M 1/7253; H04B 1/3877; H04B 1/3822; H04W 12/06; H04W 4/008; H04L 2012/40215

(57) ABSTRACT

A vehicle interface docking system for dedicated short range communication equipped user device in a vehicle. The vehicle interface docking system includes a cradle mount mountable to the vehicle within line of sight of an operator. The cradle mount retains the dedicated short range communication equipped user device. The system further includes an antenna operably connectable with the dedicated short range communication equipped user device, a power source operably connectable with the dedicated short range communication equipped user device, a communications interface providing a communications pathway between the dedicated short range communications equipped user device and a controller area network of the vehicle and the antenna, and a central processing unit executing a vehicle-to-everything program.

### CROSS-REFERENCE TO RELATED APPLICATIONS

This application claims the benefit of U.S. Provisional Application No. 62/063,443, filed on Oct. 14, 2014. The entire disclosure of the above application is incorporated herein by reference.

### FIELD

The present disclosure relates to dedicated short-range communications (DSRC) and, more particularly, a vehicle interface docking system for a DSRC-equipped user device (e.g. cell phone) in a vehicle.

### BACKGROUND AND SUMMARY

This section provides background information related to the present disclosure which is not necessarily prior art. This section provides a general summary of the disclosure, and is not a comprehensive disclosure of its full scope or all of its features.

Dedicated short-range communications (DSRC) technology enables vehicle-to-vehicle (V2V) communication for the purpose of avoiding vehicle collisions, as well as an aid to mobility and vehicular energy use in general. Similarly, vehicle to infrastructure communications (V2I) provides mobility benefits by further reducing the incidents of vehicle to infrastructure collision.

Accordingly, vehicle manufacturers are anticipating the inclusion of DSRC transmitters and receivers in newly manufactured automobiles and trucks to enable and facilitate short-range communication.

Accordingly to the principles of the present teachings, a vehicle interface docking system for a dedicated short range communication equipped user device in a vehicle is provided. The vehicle interface docking system includes a cradle mount mountable to the vehicle within line of sight of an operator. The cradle mount retains the dedicated short range communication equipped user device. The system further includes an antenna operably connectable with the dedicated short range communication equipped user device, a power source operably connectable with the dedicated short range communication equipped user device, a communications interface providing a communications pathway between the dedicated short range communications equipped user device and a controller area network of the vehicle and the antenna, and a central processing unit executing a vehicle-to-everything program.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view illustrating a vehicle-to-everything (V2X) communication system according to the principles of the present teachings.

FIG. 2 is a schematic of a design for ensuring security of the vehicle-to-everything (V2X) communication system.

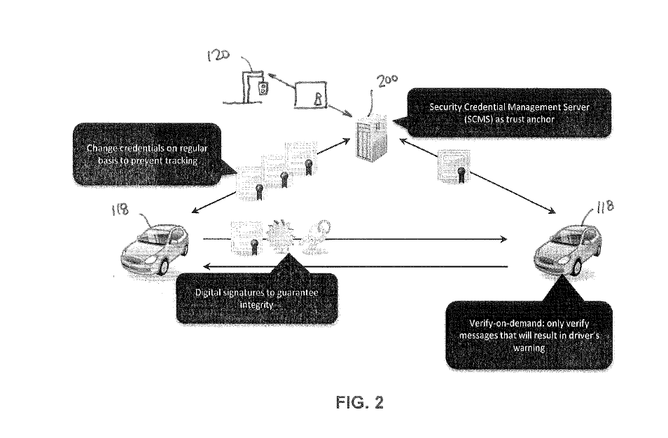

FIG. 3 illustrates system components to be utilized in accordance with the present teachings.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

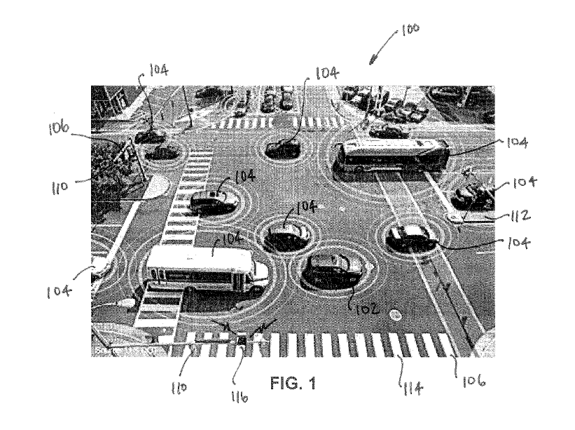

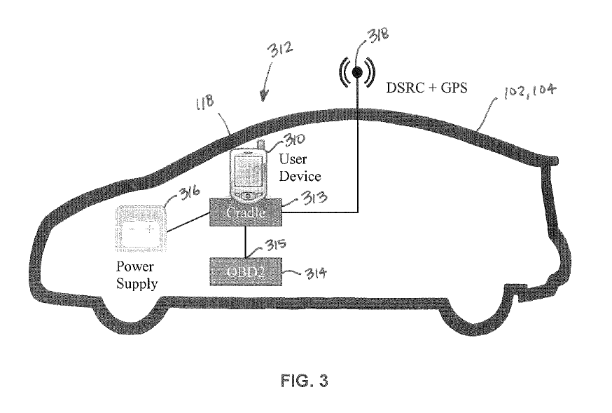

Generally, DSRC technology 100, as illustrated in FIG. 1, permits communication between a primary vehicle 102 and secondary vehicles 104 (e.g. vehicle to vehicle) and infrastructure nodes 106 (e.g. vehicle to infrastructure). To this end, vehicles and infrastructure nodes 106 (e.g. traffic lights 110, barriers 112, bridges, crosswalks 114, points of interest, and the like) will be equipped with DSRC transmitter and/or receiver units 116 that communicate over-the-air with each other. On-board units (OBU) 118 (see FIG. 3) installed in vehicles 102, 104 can broadcast position, location and time so that other receiving vehicles 102, 104 can process the information to identify potential safety threats and provide a notification or warning (e.g. forward collision warning) to the driver or other control module. Road-side units (RSU) 120 installed in infrastructure nodes 106 will broadcast safety and mobility related information (e.g. the number of seconds until a traffic light turns red, presence of emergency vehicles, environmental conditions, and the like).

Due to the importance of such safety and mobility related information, authenticating the information can be of high importance. In some cases, authentication and security may be a major technical challenge in the design of vehicle-to-everything (V2X) communication. As illustrated in FIG. 3, authentication and security may be maintained via the use of security credentials. In some applications, a security credential management server (SCMS) 200 provides security credentials to OBUs 118 and RSUs 120, which are then used to protect the over-the-air communication against manipulation and injection of false messages. In some embodiments, SCMS 200 can implement and/or manage any type of verified credentials, including but not limited to Verify-On-Demand credentials (that is, in some embodiments, verifying only information and/or data that will impact a driver warning or control input), digital signatures, and/or rolling credentials that are changed on a regular basis (e.g. time based, event based, or the like).

According to the principles of the present teachings, in some embodiments, on-board units 118 can comprise a DSRC-enabled user device 310 (FIG. 3), such as a smart phone, connectable to a vehicle interface docking system 312 for communication with the vehicle's electrical system and electronics. In some embodiments, vehicle interface docking system 312 can comprise DSRC-enabled user device 310 operably coupled to a cradle mount 313 that electrically couples DSRC-enabled user device 310 to the vehicle controller area network (CAN) bus 314, via the OBD2 port 315. This permits user device 310, via a V2X software application, to acquire relevant data from the vehicle, such as speed data, brake and throttle status, etc. In some embodiments, vehicle interface docking system 312 further comprises a power source 316, providing electrical power to user device 310 and other relevant system component, and an antenna 318, providing GPS and/or DSRC signal transmission and/or reception.

Cradle mount 313 of vehicle interface docking system 312 is mounted in such a way that the display of user device 310 is viewable by the driver.

In some embodiments, vehicle interface docking system 312 enables security mechanisms for use in combination with user device 310. In some embodiments, vehicle interface docking system 312 can extend the vehicle's and/or the DSRC-equipped user device's 310 built-in security mechanisms to cover on-board security requirements, including providing proof-of-location (user device is attached to cradle that is linked to vehicle) such that vehicle security credentials are only accessible to user device 310 when it's docked in vehicle interface docking system 312.

In some embodiments, DSRC and GPS antenna 318 can be permanently mounted on the exterior of the vehicle and operably coupled to cradle mount 313 of vehicle interface docking system 312. The GPS antenna can receive signals from GPS satellites and reports those to user device 310 via cradle mount 313 of vehicle interface docking system 312. It should be appreciated that, in some embodiments, the GPS antenna can be incorporated directly within user device 310, thereby eliminating the need for a separate antenna system for GPS reception. The DSRC antenna 318 sends and receives V2X communication.

The CAN bus 314 provides vehicle status information to user device 310 of vehicle interface docking system 312 that is then used by user device 310 to improve the precision of V2X applications (e.g. by using the vehicle speed reported via OBD2). User device 310 is operable to run the V2X applications. Therefore it will receive the GPS signal (either from its internal GPS antenna or from the externally mounted GPS antenna), receive the DSRC messages received via the DSRC antenna 318, process all information, and then create and output DSRC messages that are eventually broadcast via the DSRC antenna 318 and/or displayed or output to the driver.

In some embodiments, user device 310 is connected to vehicle interface docking system 312 via a wireless or wired connection. User device 310 can comprise a display and a computing platform. By way of non-limiting example, user device 310 can be a smart phone, a tablet computer, or any mobile device having a display. It should be understood that in some embodiments, user device 310 can comprise a device without a display, but providing other alert indicia, such a lighting, audio, vibration, and the like.

Vehicle interface docking system 312 connects to power supply 316, CAN bus 314 via OBD2 port 315, and DSRC and GPS antenna 318. Vehicle interface docking system 312 then provides an easy-to-use connection to user device 310 such that user device 310 can be setup in a vehicle in a few seconds. Vehicle interface docking system 312 connects to user device 310 either via wired or wireless connection (e.g. using Bluetooth data communication and wireless power charging). Vehicle interface docking system 312 also provides a physical apparatus in which user device 310 can be mounted so that the vehicle's driver can easily see user device display messages. Vehicle interface docking system 312 implements a mechanism to ensure that it is actually installed in a vehicle (e.g. by verifying the OBD2 data and the DSRC and GPS data, and/or by physical means such as a sealed installation). Vehicle interface docking system 312 provides a security service to user device 310 such that user device 310 will only be able to use security credentials meant for use by a vehicle while being mounted in vehicle interface docking system 312.

The present teachings provide a number of advantages, such as, but not limited to, the use of the technology in any legacy vehicle that does not have an integrated DSRC communication system, including cars, trucks, motorcycles, scooters, bicycles, busses, trains, trams, etc. Compared to permanently installed retrofit safety devices, the present teachings provide an inexpensive solution and improved adaptability, because the user provides the computational platform and display by virtue of user device 310. The solution further enables one to use the same user device 310 in several legacy vehicles, and to update user device 310 regularly without upgrading vehicle interface docking system 312 in the vehicle. It is expected that vehicle interface docking system 312 will facilitate increased acceptance, thereby more rapidly increasing the proliferation of a V2X system.

This technology was tested in the USDOT sponsored Safety Pilot Model Deployment that was led by UMTRI. More than 2800 cars were equipped with OBUs and 30 RSUs were deployed in Ann Arbor. The invention at hand relates to the OBU. Several kinds of OBUs were deployed in Safety Pilot: integrated safety devices (ISD) were seamlessly integrated in vehicles, connected to externally mounted GPS and DSRC antennas, and connected to the in-vehicle controller area network (CAN) and to integrated driver notification systems (e.g. red warning lights in dashboard display). Retrofit safety devices (RSD) were connected to the CAN and to externally mounted GPS and DSRC antennas, and a display was installed in the vehicle to display the driver warnings (similar to an integrated aftermarket navigation system). Aftermarket safety devices (ASD) were not connected to the CAN but to externally mounted GPS and DSRC antennas, and a display was installed in the vehicle to display the driver warnings.

It should be understood that variations of the present teachings are anticipated, including, but not limited to, a user device 310 having a built-in DSRC and/or GPS antenna, thereby eliminating the need for DSRC and/or GPS antenna 318. In some embodiments, vehicle interface docking system 312 is not required to connect OBD2 port 315 and/or CAN bus 314. Power supply 316 may be any power supply, such as on-board power, solar, user device power, or other means. In some embodiments, communication between vehicle interface docking system 312 and OBD2 port 315, as well as DSRC and GPS antenna 318, might be based on a wired or wireless connection. In some embodiments, user device 310 may employ a cellular or other Internet connection to support the V2X application.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle interface docking system for a dedicated short range communication equipped user device in a vehicle, the vehicle interface docking system comprising:
a cradle mount mountable to the vehicle within line of sight of an operator, the cradle mount retaining the dedicated short range communication equipped user device;
an antenna operably connectable with the dedicated short range communication equipped user device;
a power source operably connectable with the dedicated short range communication equipped user device;
a communications interface providing a communications pathway between the dedicated short range communications equipped user device and a controller area network of the vehicle and the antenna; and
a central processing unit executing a vehicle-to-everything program, the program being stored in non-volatile memory.

2. The vehicle interface docking system according to claim 1 wherein the central processing unit receiving at least speed data from the vehicle via the controller area network.

3. The vehicle interface docking system according to claim 1 wherein the antenna is a combination DSRC antenna and GPS antenna.

4. The vehicle interface docking system according to claim 1 wherein the antenna is a DSRC antenna.

5. The vehicle interface docking system according to claim 1 wherein the power source is a vehicle power source.

6. The vehicle interface docking system according to claim 1 wherein the power source is a user device power source.

7. The vehicle interface docking system according to claim 1 wherein the communications interface is a wireless interface.

8. The vehicle interface docking system according to claim 1 wherein the communications interface is a wired interface.

9. The vehicle interface docking system according to claim 1 wherein the communications interface employs a security credential management server authenticating communications between the dedicated short range communications equipped user device and the controller area network.

10. A vehicle interface docking system for a dedicated short range communication equipped user device in a vehicle, the vehicle interface docking system comprising:
a dedicated short range communications equipped user device executing a vehicle-to-everything program, the program being stored in non-volatile memory;
a cradle mount mountable to the vehicle within line of sight of an operator, the cradle mount releasably retaining the dedicated short range communication equipped user device;
an antenna operably coupled with the dedicated short range communication equipped user device, the antenna providing at least one of a GPS signal and a DSRC signal;
a power source operably coupled with the dedicated short range communication equipped user device; and
a communications interface providing a communications pathway between the dedicated short range communications equipped user device and a controller area network bus of the vehicle.

11. The vehicle interface docking system according to claim 10 wherein the dedicated short range communications equipped user device receives at least speed data from the vehicle via the controller area network bus.

12. The vehicle interface docking system according to claim 10 wherein the antenna provides both the GPS signal and the DSRC signal.

13. The vehicle interface docking system according to claim 10 wherein the power source is a vehicle power source.

14. The vehicle interface docking system according to claim 10 wherein the power source is a user device power source.

15. The vehicle interface docking system according to claim 10 wherein the communications interface is a wireless interface.

16. The vehicle interface docking system according to claim 10 wherein the communications interface is a wired interface.

17. The vehicle interface docking system according to claim 10 wherein the communications interface employs a security credential management server authenticating communications between the dedicated short range communications equipped user device and the controller area network bus.
